(19) United States
(12) Patent Application Publication
(10) Pub. No.: US 2013/0262161 A1
(43) Pub. Date: Oct. 3, 2013

(54) TICKET PROCESSING METHOD AND PROGRAM OF THE SAME

(71) Applicants: Shinnosuke MATSUDA, Tokyo (JP); Akihiro ICHIMURA, Tokyo (JP); Ryo SHIMOMURA, Tokyo (JP)

(72) Inventors: Shinnosuke MATSUDA, Tokyo (JP); Akihiro ICHIMURA, Tokyo (JP); Ryo SHIMOMURA, Tokyo (JP)

(73) Assignee: LIVE STYLES INC., Tokyo (JP)

(21) Appl. No.: 13/852,622

(22) Filed: Mar. 28, 2013

(30) Foreign Application Priority Data
Mar. 29, 2012 (JP) 2012-075538
Oct. 10, 2012 (JP) 2012-225224

(51) Int. Cl. G06Q 10/02

(52) U.S. Cl. CPC G06Q 10/02
USPC 705/5

(57) ABSTRACT

In the ticket processing system 1, a ticket buyer operate a terminal apparatus 11 to accesses a server 15 and downloads ticket data (electronic ticket). And, in an event meeting place, a ticket image is displayed on a screen of the terminal apparatus 11, and entrance processing is performed by electronic update processing on the screen. Electric thicket is used on the screen, and the information of using the electric thicket is transmitted to the server 15 when the terminal apparatus 11 becomes to be able to communicate with the server 15.

### FIELD OF INVENTION

The present invention is related to a method of ticket processing and a program of the same which perform ticket processing of event.

### BACKGROUND

A ticket processing system using a smart phone and a cellar phone is known conventionally.

In the conventional ticket processing system, ticket data is downloaded to a smart phone by the ticket purchase processing by a user.

And, at the entrance of the event, a QR cord (trademark) is displayed on a screen of the smart phone. And the displayed QR cord is read by a reader and transmitted to a server. The server verifies effectiveness of the ticket.

However, the conventional system cannot use in a place where the smart phone cannot communicate with the server because it is necessary to confirm the information the QR cord which is read by the smart phone.

### SUMMARY OF THE INVENTION

The purpose of the present invention is provide a ticket processing method and program of the same which can perform ticket processing in the environment that cannot communicate with a server.

A first invention is a method for ticket processing, comprising: a first step downloading a ticket data to a portable terminal apparatus from a server; a second step taking the ticket data which is downloaded in a ticket processing application program which is started in the portable terminal apparatus; a third step in which the portable terminal apparatus displays the image according to the ticket data on a screen based on the ticket processing application program; and a fourth step in which the portable terminal apparatus detects a predetermined operation on a screen when a movement course of contact position of finger of user is a predetermined pattern decided beforehand and updates a status data indicating use history of the ticket data when the predetermined operation is detected.

A second invention is a program which is downloaded in a portable terminal apparatus which comprises: a touch panel detecting the coordinate of the contact position in the screen, and a control circuit identifying input operation based on the coordinate detected in the touch panel and performing a processing according to the input operation which is identified, and which makes the control circuit execute a first step downloading a ticket data to a portable terminal apparatus from a server; a second step taking the ticket data which is downloaded in a ticket processing application program which is started in the portable terminal apparatus; a third step in which the portable terminal apparatus displays the image according to the ticket data on a screen based on the ticket processing application program; and a fourth step in which the portable terminal apparatus detects a predetermined operation on a screen when a movement course of contact position of finger of user is a predetermined pattern decided beforehand and updates a status data indicating use history of the ticket data when the predetermined operation is detected.

### BRIEF DESCRIPTION OF THE DRAWINGS

FIG. 1 is a view for explaining a ticket processing system of the present invention.

FIG. 2 is a block diagram of a ticket processing system of the present invention shown in FIG. 1.

FIG. 3 is a block diagram of a terminal apparatus of ticket buyer shown in FIG. 2.

FIG. 4 is a block diagram of a server shown in FIG. 2.

FIG. 5 is a flowchart for explaining operation of the ticket processing system shown in FIG. 1 and FIG. 2.

FIG. 6 is a view for explaining an example of screen of a terminal apparatus of ticket buyer.

FIG. 7 is a flowchart for explaining operation of the ticket processing system of a second embodiment shown in FIG. and FIG. 2.

FIG. 8 is a view for explaining a third embodiment of the present invention.

FIG. 9 is a flowchart for explaining of a fourth embodiment of the present invention.

FIG. 10 is a flowchart for explaining of a fifth embodiment of the present invention.

FIG. 11 is a flowchart for explaining of a seventh embodiment of the present invention.

FIG. 12 is a flowchart for explaining of an eight embodiment of the present invention.

FIG. 13 is a flowchart for explaining of an ninth embodiment of the present invention.

### THE PREFERRED EMBODIMENT OF THIS INVENTION

A ticket processing system of embodiments of the present invention will be explained.

### First Embodiment

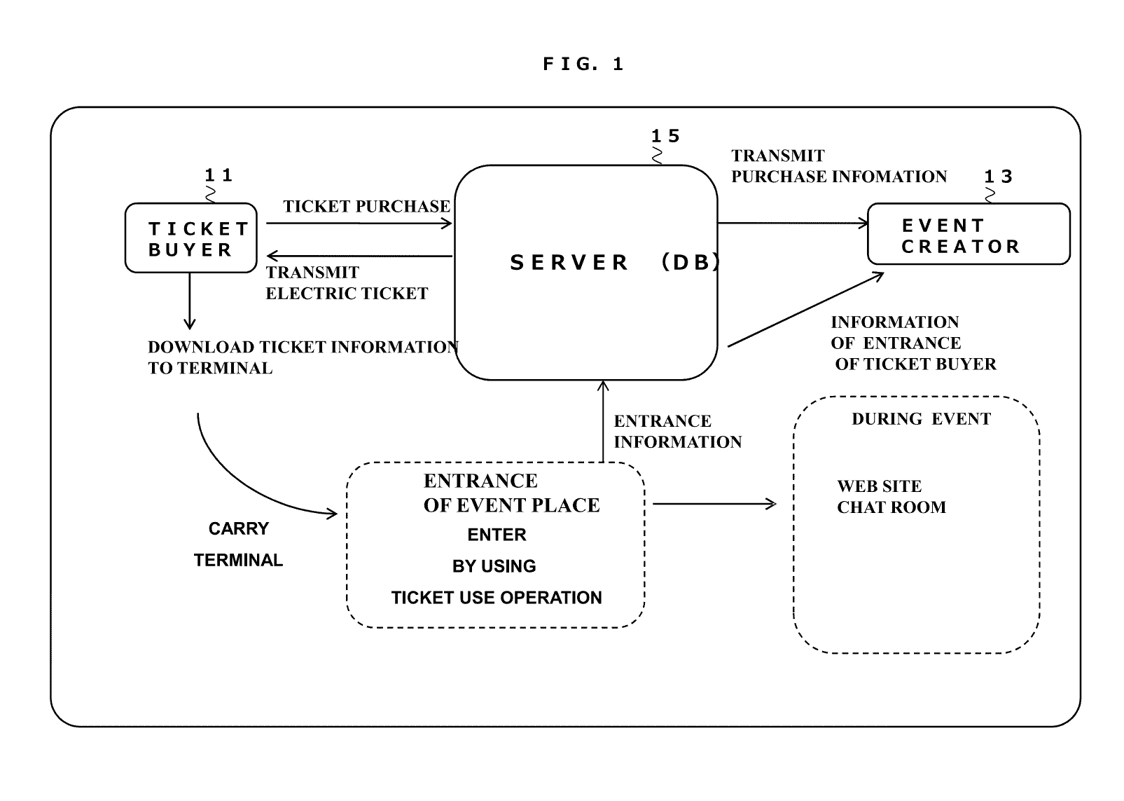

As shown in FIG. 1, in the ticket processing system 1, a terminal apparatus 11 of ticket buyer accesses to a server 15 and download a ticket data (electric ticket) to the terminal apparatus 11.

Then ticket buyer displays a thicket image on a display of the terminal apparatus 11 at event place to process for entrance when detecting the ticket use operation that is operation to cut paper on a screen artificially.

The ticket use operation is an operation moving a finger as if tearing off paper.

A status data relating to a use of ticket stored in the terminal apparatus 11 is transmitted to the server 15 when becoming able to communicate with the server 15.

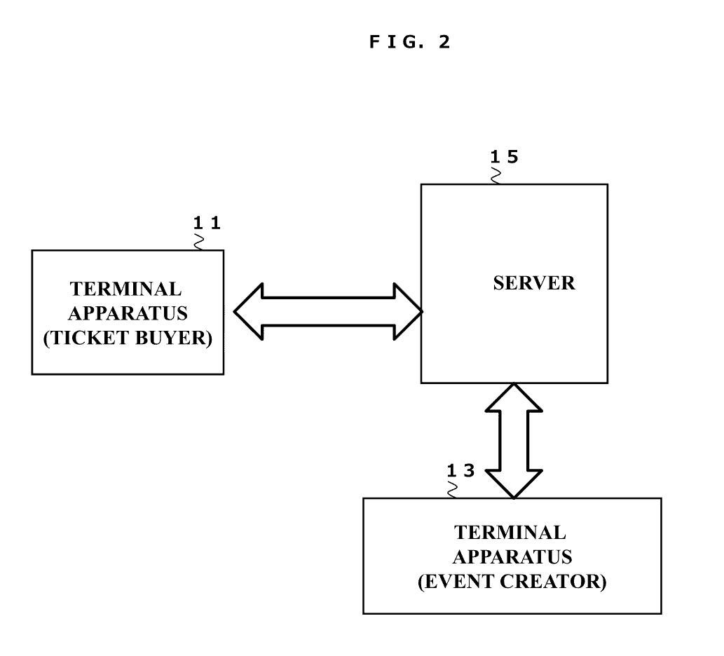

For example, the ticket processing system 1 is realized using the terminal apparatus 11, the terminal apparatus 13 and the server 15 as shown in FIG. 2.

The terminal apparatus 11 is a smart phone or a cellar phone which a ticket buyer uses.

The terminal apparatus 13 is a personal computer or a smart phone which an event creator uses.

The server 15 is a server which a company providing ticket processing service uses.

[terminal apparatus 11]

The terminal apparatus 11 has, for example, a communication unit 21, a display 22, a operation unit 23, a memory 24 and a processing circuit 25. These components are connected through a data line 20.

The communication unit 21 is used to communicate with the server 15 shown in FIG. 2.

The display 22 displays various screens provided by a program PRG which is executed by the processing circuit 25. The display 22 displays a screen for update processing described later and a coupon image.

The operation unit 23 is an operation means such as a touch panel function of the display 22, a keyboard or a mouse.

The memory 24 stores a program PRG executed by the processing circuit 25 and a data used in the processing of the processing circuit 25.

The processing circuit 25 executes the program PRG and controls a ticket related processing of the terminal apparatus 11.

Processing of the terminal apparatus 11 is described in the program PRG.

[server 15]

The server 15 has, for example, a communication unit 121, a display 122, a operation unit 123, a memory 124 and a processing circuit 125. These components are connected through a data line 120.

The communication unit 121 is used to communicate with the terminal apparatus 11 and the terminal apparatus 13 shown in FIG. 2.

The display 122 displays various screens provided by a program PRG which is executed by the processing circuit 125.

The operation unit 123 is an operation means such as a touch panel function of the display 122, a keyboard or a mouse.

The memory 124 stores a program executed by the processing circuit 125 and a data used in the processing of the processing circuit 125.

The processing circuit 125 executes the program and controls a ticket related processing of the server 15.

Processing of the server 15 is described in the program.

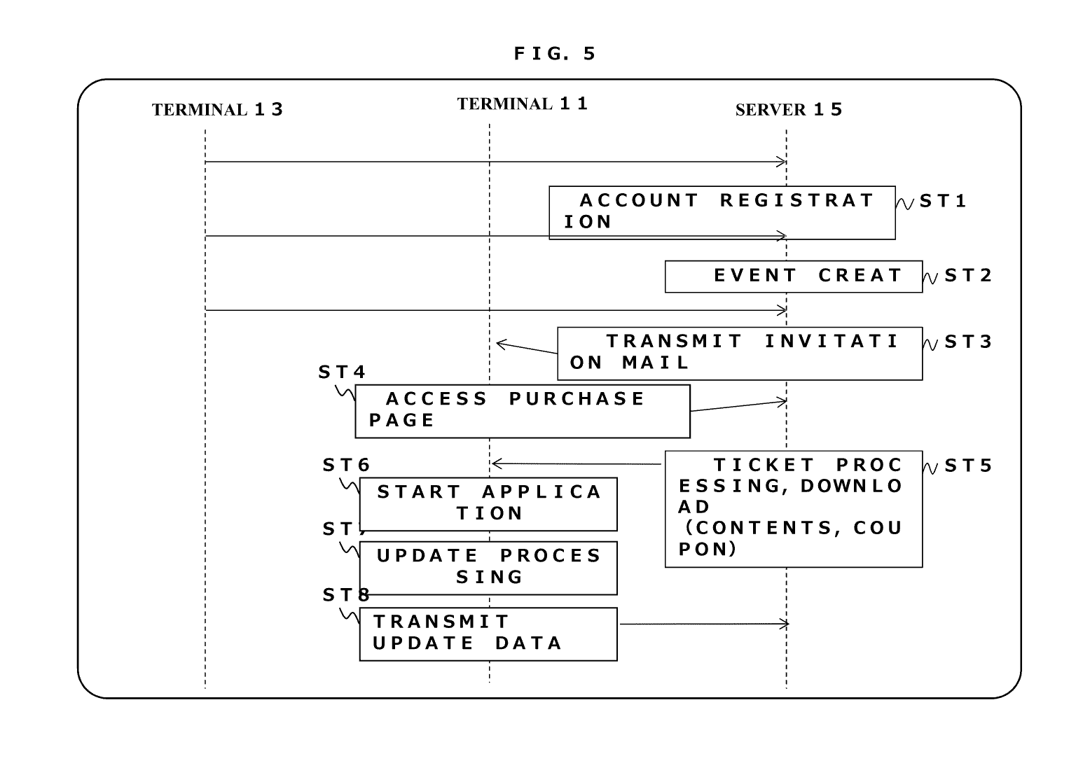

Below operation of the ticket processing system 1 will be explained with reference to FIG. 5.

Step ST1:

An event creator operates the terminal apparatus 13 and accesses the server 15 to register own account and password.

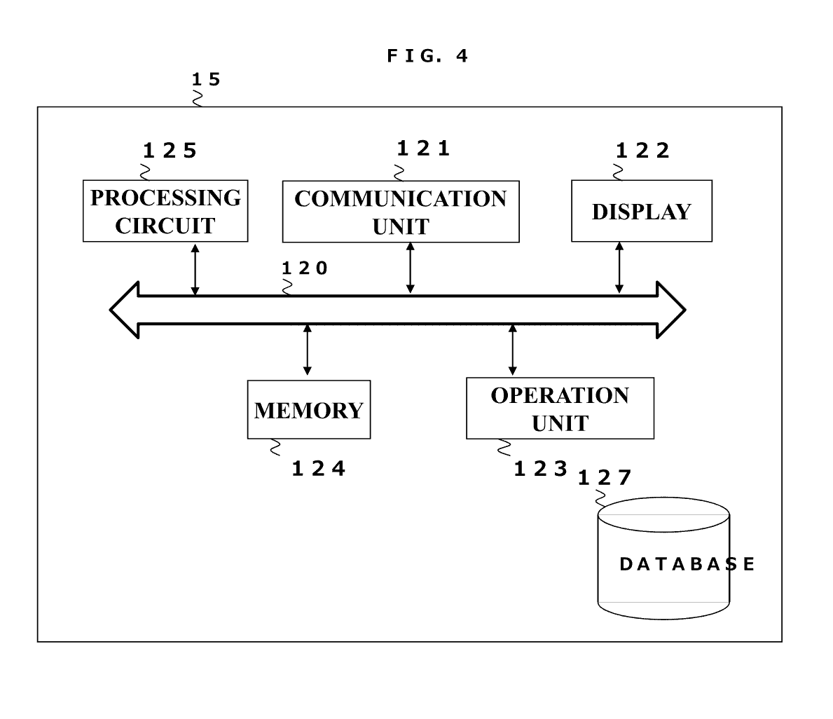

The processing circuit 125 of the server 15 shown in FIG. 4 stores the personal information of the event creator to the database 127 corresponding the account and the password.

Step ST2:

The processing circuit 125 of the server 15 performs event making processing based on the operation of the terminal apparatus 11.

The event making processing performs generating an event web page in which contents of the event is described and a link to a ticket purchase page. Here, ticket price may be decided.

It may allow the event creator to select whether or not the event page will be open to the public.

Step ST3:

The processing circuit 125 of the server 15 transmits an invitation email in which a link to the event web page is inserted using an mail address of a designated invited guest according to the operation of the event creator. The terminal apparatus 13 may transmit the invitation email.

Step ST4:

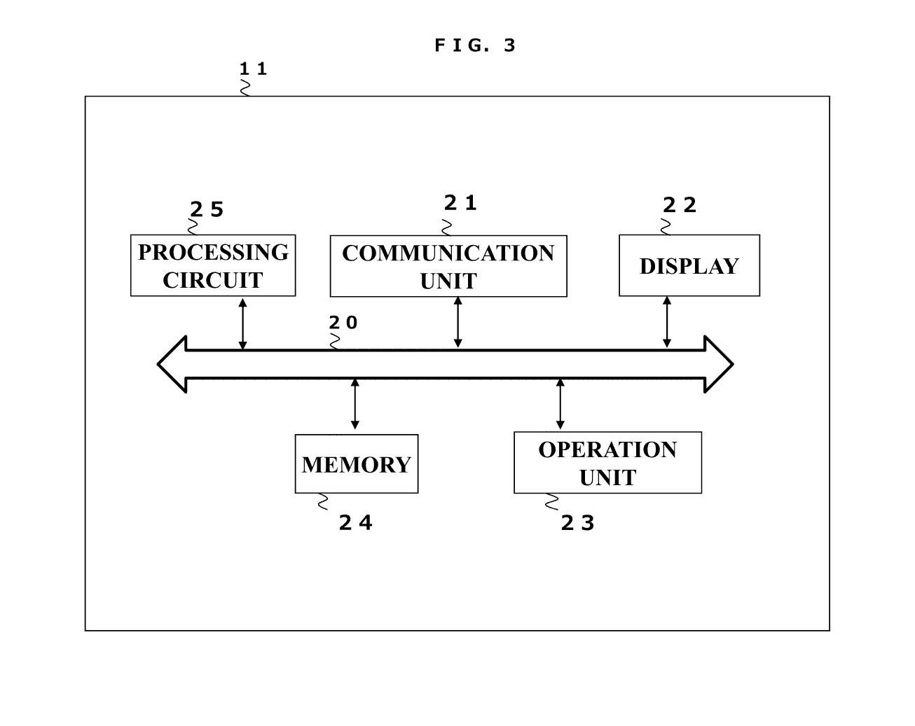

The invited guest accesses the event web page included in the invitation email that received through the communication unit 21 of the terminal apparatus 11 shown in FIG. 3 and confirms event contents on a screen displayed on the display 22.

Step ST5:

When the invited guest hopes for the ticket purchase of the event, the invited guest accesses to the ticket purchase page where a link is displayed in the event web page and settles the ticket purchase.

For example, the server 15 performs the accounting to the both sides of a ticket buyer and the event creator.

And the processing circuit 125 of the server 15 generates the ticket data of the event and transmits it to the terminal apparatus 11.

Further the processing circuit 125 connects information such as the ID of the ticket buyer with the event and register it in the database 127.

In addition, the terminal apparatus 11 stores the ticket data which received from the server 15 into the memory 24.

Step ST6:

The ticket buyer operates the operation unit 23 of the terminal apparatus 11 at the entrances of the event meeting place on the event day and starts a ticket processing application program stored in the memory 24.

The ticket data stored in the memory 24 are read for a ticket processing application program by the start.

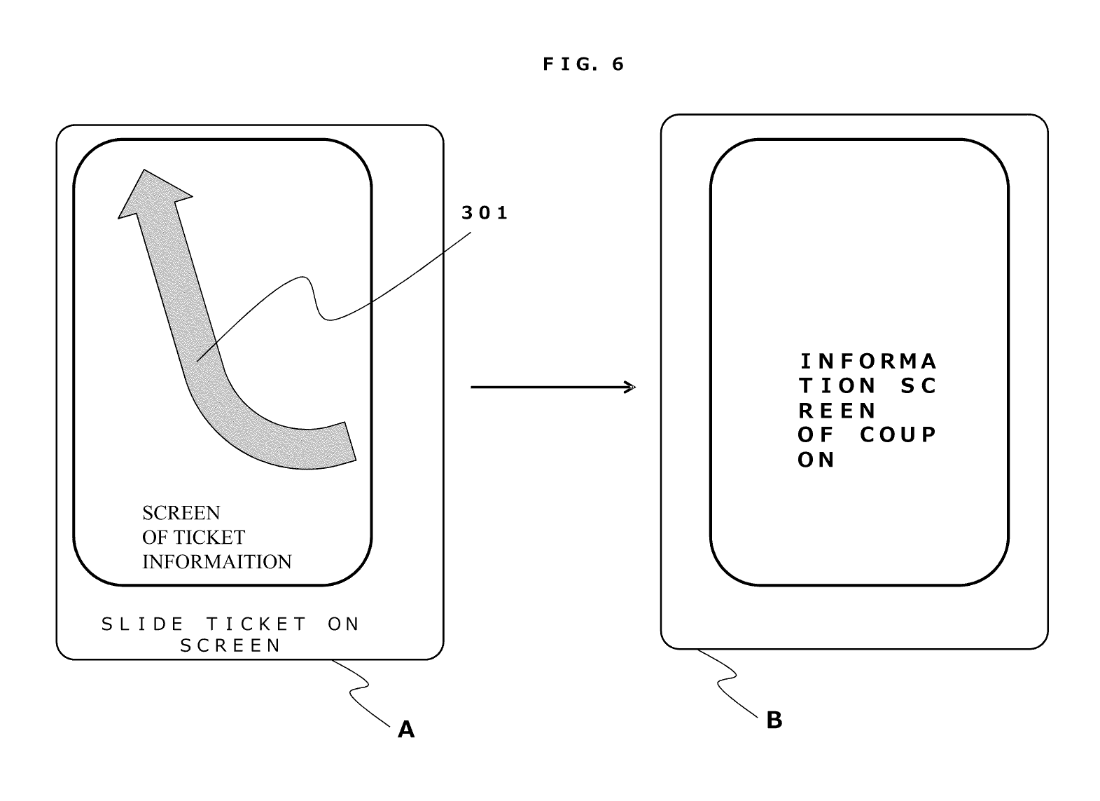

Then the processing circuit 25 of the terminal apparatus 11 displays a ticket screen in the display 22 as shown as “A” in FIG. 6 according to the ticket processing application program.

In addition, the transmission of ticket data from the server 15 to the terminal apparatus 11 may be performed in step ST6 not in step ST5.

Step ST7:

The event staff performs ticket use operation along a pattern 301 shown as “A” in FIG. 6 on a ticket screen displayed on the display 22 in step ST6. The pattern 301 is detected by a touch panel function of the display 22 and is output to the processing circuit 25.

The processing circuit 25 judges whether or not the pattern 301 matches the ticket use operation pattern stored beforehand, and performs update processing when it is judged they are matched and the status data stored in the memory 24 indicates an unused state (or available state).

The processing circuit 25 performs processing for updating the status data stored in the memory 24 to indicate entrance processing finished and screen update processing transit the screen from “A” of FIG. 6 to a screen after update processing shown as “B” of FIG. 6 (e. g., a coupon indication screen and the lottery number indication screen of a product or a service).

The status data indicates whether or not the entrance processing finished and a update processing of entrance time when entrance processing has finished.

In addition, the processing circuit 25 may display the alert screen such as “Enter after using thicket”. etc, on the display 22 before starting update processing and start updating processing on the condition that “yes” operation is performed by user. Consequently wrong update processing may be prevented.

In step ST7, the processing circuit 25 does not have to communicate with the server 15.

Further the processing circuit 25 outputs a sound to punch the ticket as update processing and make the terminal apparatus 11 vibrate by a predetermined pattern.

Step ST8:

The processing circuit 25 of the terminal apparatus 11 reads a status data from the memory 24 to transmit to the server 15 when judging the communication unit 21 is possible to communicate with the server 15 and the status data is updated.

As described above, according to the ticket processing system 1 the terminal apparatus 11 does not need to communicate with the server 15 when performing a ticket processing in the meeting place of the event.

In other words, the status data stored in the memory 24 becomes to be status indicating entrance processing is finished after the update processing at the meeting place of the event. Therefore it is possible to judge the thicket is already used even if thicket holder tries to use it again. Then it is possible to prevent abuse.

Further as shown in the step ST8, the terminal apparatus 11 transmits the status data to the server 15 with an ID of a ticket buyer when the terminal apparatus 11 become able to communicate with the server 15. Therefore the server 15 can get the ticket use status of the ticket buyer.

Further in the ticket processing system 1, a leader for reading the ticket data in an event meeting place is unnecessary and, it is possible to handle a digital ticket data without a leader.

Further if communication environment is maintained in an event meeting place, the server 15 can acquire an update processing result in real time.

### Second Embodiment

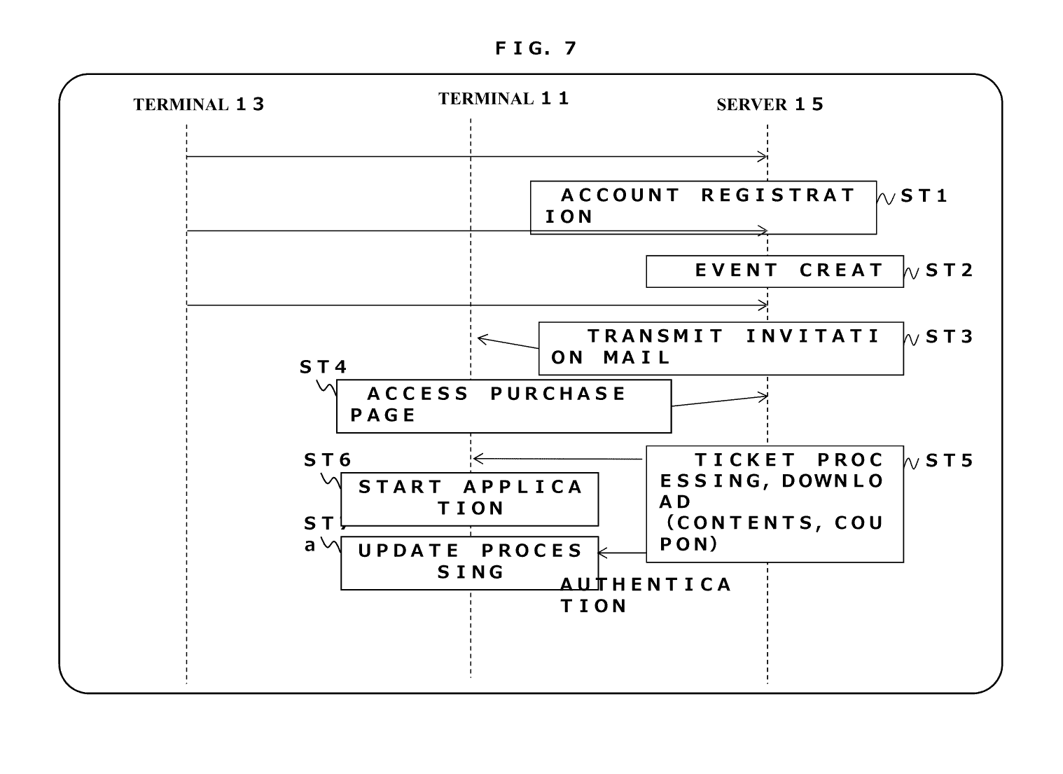

In the ticket processing system 1 of the present invention, the processing of the steps ST1 to ST6 shown in FIG. 7 is basically the same with that of the first embodiment, but the processing of the step ST7a is different from the that of the first embodiment.

In the present embodiment, a communication between the terminal apparatus 11 and the server 15, an authentication of the validness of the ticket data in the server 15 and a transmission of the result to the terminal apparatus 11 are performed in the update processing of the step ST7a as described below.

And the terminal apparatus 11 makes the update processing valid or permits the update processing only when the terminal apparatus 11 judges that ticket data is valid.

By this it is possible to prevent that one user holds a plurality of terminal apparatuses 11, makes download the ticket data to each terminal apparatus 11 and makes a plurality of persons use the ticket data unfairly.

### Third Embodiment

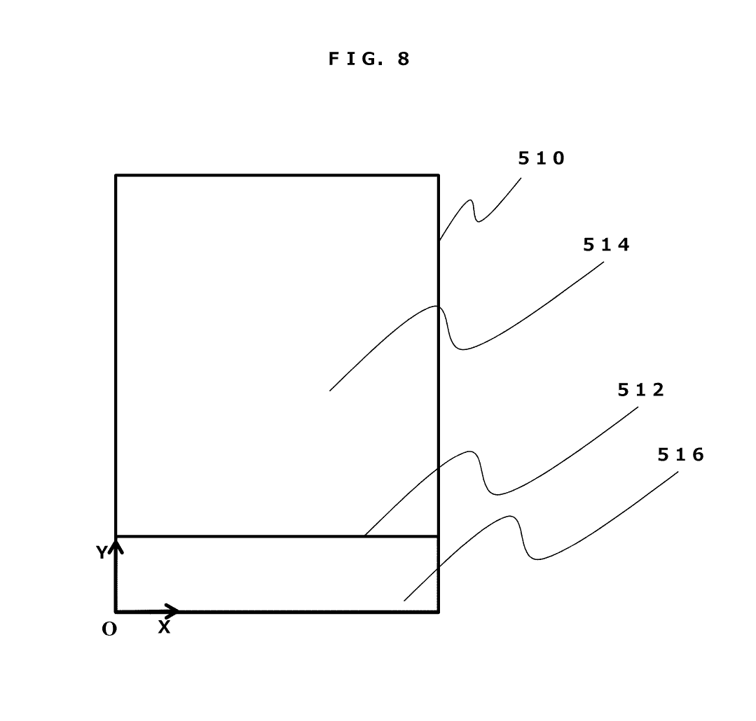

In the present embodiment, in the event generating processing in the step ST2 shown in the FIG. 5 and FIG. 7, the processing circuit 125 of the server 15 stores a cutting off position data indicating the designated cutting off position in memory 24 when inputting a cutting off position designation indicating the cutting off position 512 on the screen 510 of the display 22 of the terminal apparatus 11 according to the operation of the event creator of the terminal apparatus 11 as shown in FIG. 8.

And the processing circuit 25 of the terminal apparatus 11 updates status data of the ticket data to indicate the entrance processing finished when detecting that the movement course of the predetermined pattern exists in the area to be updated 514 (domain of the screen upper part with respect to the cutting off position, domain to be cut off) of the ticket image shown on the screen based on cutting off position data read from the memory 24 in the update processing of the step ST7 shown in FIG. 5 or step ST7a shown in FIG. 7

Further the processing circuit 25 updates an image in the area to be updated 514 on the screen 510 to an image after the update processing from an image before the update processing when detecting the movement course of the predetermined pattern exists.

The processing circuit 25 displays the same image before and after the update processing in the ticket stub area 516.

The memory 24 of the terminal apparatus 11 stores a plurality of ticket use operation patterns as the predetermined pattern and images after update processing corresponding to each of the plurality of patterns.

The processing circuit 25 compares the detected pattern 301 with the plurality of ticket use operation patterns stored beforehand and judges whether or not the detected pattern 301 matches at least one of the ticket use operation patterns. Then the processing circuit 25 performs update processing when judging the detected pattern 301 matches one of the ticket use operation patterns and the status data stored in the memory 24 indicates not used.

Note that, the processing circuit 25 stores the identification information of the ticket use operation pattern with which the pattern 301 matched and the identification information of the thicket data.

And the processing circuit 25 stores the information indicating the ticket use operation pattern with which the pattern 301 matched.

For example, when image data after the update processing are corresponded with each of a plurality of the ticket use operation patterns, the processing circuit 25 displays the image after the update processing corresponding to the ticket use operation pattern in the area to be updated 514 of the display 22.

The event staff checks attribute of the ticket holder which can be grasped visually to do ticket use operation by the ticket use operation pattern corresponding to the attribute.

By this it becomes possible to connect attribute of the ticket holder obtained at event place to the ticket data.

In the present embodiment, for example, the photograph of the face data of the ticket buyer may be included in the ticket data.

Therefore the processing circuit 25 may display the photograph of the face data included in the ticket data based on a ticket processing application program in the ticket stub area 516 on the screen 510 in step ST7 or ST7a.

By this, it is possible to judge whether or not the ticket holder is authorized by comparing face of the user and the face of the user shown in the ticket stub area 516 at the time of update processing. Therefore it is possible to prevent effectively buy and sell of ticket data between users illegally.

Further, the seat information of the event meeting place included in ticket data may be displayed on the ticket stub area 516.

### Fourth Embodiment

In the present embodiment, the following processing is performed in the step ST5 shown in FIG. 5.

Step ST5:

The processing circuit 125 of the server 15 generates ticket data of the event after accounting, and transmit the ticket data to the terminal apparatus 11.

The ticket data includes at least one information of a position condition and a time condition for permitting the ticket data to be updated.

For example, the position condition is an address of the event meeting place. And the time condition is the date, start time and end time of the event.

Step ST7:

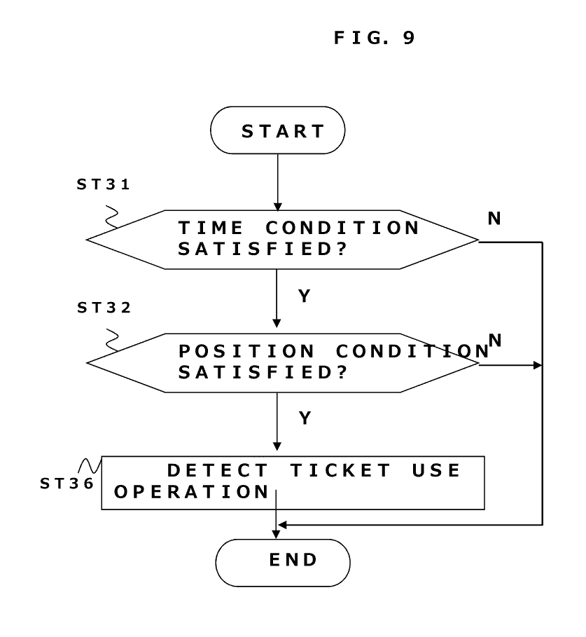

In this embodiment, the processing circuit 25 of the terminal apparatus 11 judges whether or not the time indicated by a built-in timer satisfies the time condition indicated by the ticket data when comparing the pattern 301 and the ticket use operation pattern stored beforehand and judges these patterns are matched (Step ST31 shown FIG. 9).

And the processing circuit 25 obtains the positional information of the terminal apparatus 11 when judging that the time condition is satisfied and judges whether or not the position information obtained satisfies the position condition indicated by the ticket data (step ST32).

The processing circuit 25 performs the update processing when judging the position condition is satisfied and the status data indicates before update (step ST36).

According to the present invention, when the position condition or the time condition is not satisfied the update processing will not performed, therefore unintended update processing will be prevented.

### Fifth Embodiment

In the present embodiment, the terminal apparatus 11 downloads a plurality of screen image data after cutting off when downloading the ticket data from the server 15.

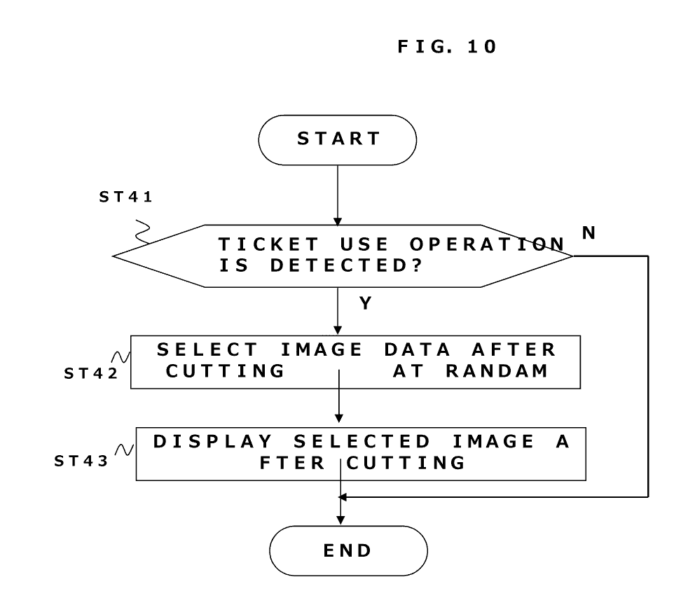

Then the processing circuit 25 selects one screen image data among the screen image data after cutting based on a predetermined selection pattern which is known only by operator after detecting the ticket use operation in the update processing of the step ST7 (step ST41 shown in FIG. 10).

For example, the selection pattern defines screen image data to be selected depending on a day.

And the processing circuit 25 performs the screen display after cutting off based on the selected screen image data (step ST43).

According to the present invention it is possible to prevent unfair use of the ticket.

### Sixth Embodiment

In the present embodiment, the terminal apparatus 11 downloads contents data or coupon data in relation to the ticket data when downloading the ticket data from the server 15 in the step ST5.

The ticket buyer can used these contents data or coupon data before the update processing.

The processing circuit 25 stores the history data indicating the history of the use of the contents data or coupon data in the memory 24.

And the processing circuit 25 transmits the history data stored in the memory 24 to the server 15 in the update processing of the step ST7.

According to the present invention, it is possible to collect use history of contents data or coupon data by the ticket buyer.

### Seventh Embodiment

In the present embodiment, the ticket data includes an available (use) number data indicating an available number of times

The available number data is used for judging the ticket data is available. Further the ticket data includes an used number data indicating the number of times already used.

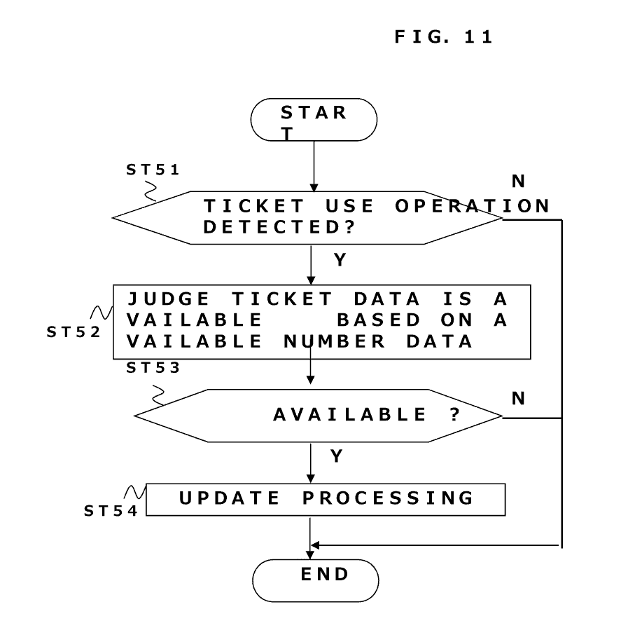

When the processing circuit 25 detects the ticket use operation in update processing of step ST7 (step ST51 of FIG. 11), the processing circuit 25 judges whether or not the ticket data is available based on the available number data and the used number data of the ticket data. Specifically, the processing circuit 25 judges that the ticket data is available when available number is larger than used number (step ST52).

The processing circuit 25 performs update processing when judging the ticket data is available (step ST53).

According to the present embodiment, the ticket data can be used a plurality of times.

Note that, in the present invention, the ticket buyer may input a number to use the ticket data by the ticket use operation of the step ST7 of the FIG. 5.

The processing circuit 25 judges whether or not the ticket data is available based on the number to use the ticket data input, the available number and used number data of the ticket data (step ST52).

Specifically, the processing circuit 25 judges the ticket data is available when the number that t subtracted the used number from the available number is not less than the number to use.

### Eight Embodiment

In the present embodiment, the terminal apparatus 11 downloads a data including a link information to other web sites as screen image data after the update processing at the time of the downloading of the ticket data from the server 15 in step ST5.

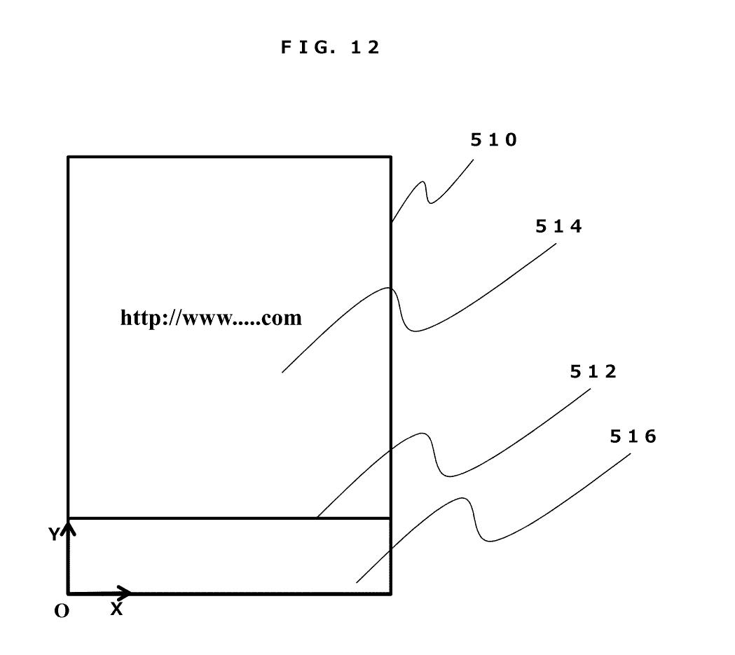

And the processing circuit 25 displays the link information to other web sites on the screen based on screen image data after the update processing when detecting the ticket use operation in the update processing of the step ST7 as shown in FIG. 12.

In this way it is possible to guide the user to other related sites after update processing.

### Ninth Embodiment

A coordinate data (X, Y) which indicates the contact position by finger of the user on the screen 510 which is input from the display 22 (operation unit 23) having function of a touch panel is stored sequentially in the memory 24.

On the screen 510, X, Y coordinates are defined beforehand as shown in FIG. 8.

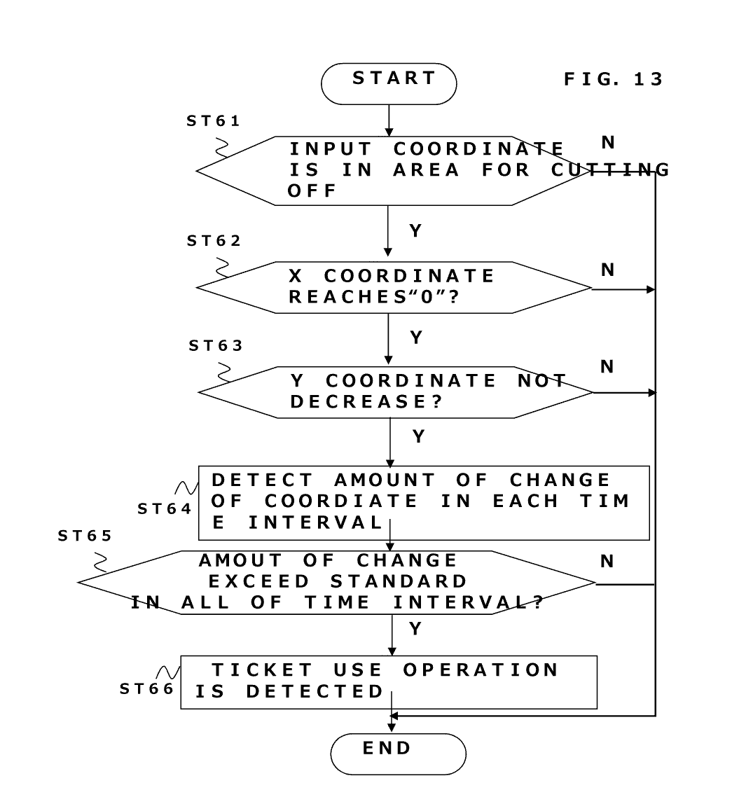

Explanation will be made using the FIG. 13.

Step ST61:

The processing circuit 25 judges whether or not the coordinate data (X, Y) which is input according to the operation performed by contacting on the screen 510 by fingers of the user in continuously is positioned in the area to be updated 514 defined in the third embodiment and proceeds to the step ST22 when the judgment is affirmative.

The operation moves over the screen 510 while maintaining a contact state after the user came into contact on the screen 510 with fingers first.

Note that, when the coordinate data (X, Y) which is input enters in the ticket stub area 516, negative judgment will be done. Then the ticket use operation is not detected.

Step ST62:

The processing circuit 25 judges as affirmative when the coordinate data X (horizontal direction of the screen 510) which is input in step ST61 reaches “0” (i.e., the horizontal left edge of the screen 510). The processing circuit 25 proceeds to the step ST63 when the judgment is affirmative. Otherwise, the processing circuit 25 judges as negative and not determines the ticket use operation.

Step ST63:

The processing circuit 25 judges as affirmative when the coordinate data Y (vertical direction of the screen 510) which is input in step ST61 decreases during the operation. The processing circuit 25 proceeds to the step ST64 when the judgment is affirmative. Otherwise, the processing circuit 25 judges as negative and not determines the ticket use operation.

Step ST64:

The processing circuit 25 divides the time between a first timing in which the coordinate data (X, Y) is input first in the step ST21 (timing user contact the screen 510 first) and a second timing in which it is judged that the coordinate data X reaches to “0” in the step ST22 by a predetermined time distance.

And the processing circuit 25 calculates the amount of change of the coordinate data (X, Y) in each divided time distance.

Step ST65:

The processing circuit 25 judge whether or not the amount of change of each time distance calculated in the step ST64 is not less than a predetermined standard and proceeds to the step ST26 when the judgment is affirmative. Otherwise, the processing circuit 25 judges as negative and not determines the ticket use operation.

The ticket use operation by finger on the screen will be performed normally with speed higher than a predetermined speed. The processing circuit 25 can detect the operation with highly precise.

Step ST66:

The processing circuit 25 judges the ticket use operation is performed.

In the present embodiment, a ticket use operation on the screen 510 which is similar to an operation to cut off a real ticket is detected with highly precise.

That is the ticket use operation on the screen 510 is similar to a operation in which user holds the side of main thicket portion of the thicket corresponding to the area to be updated 514 by finger and moves the finger to the direction which move away from a cutting line.

In other words, according to the ticket processing system 1, it is possible to detect the pseud ticket use operation similar to real ticket use operation with highly precise based on the movement course of the finger of the user in the screen 510.

The present invention is not limited to the above embodiments.

It will be appreciated by those skilled in the art which various modifications, combinations, sub-combinations, and replacements may be made in part or all of the components within the technical scope and its equivalents of the present invention.

In the present embodiment, the thicket processing of an event is explained as example, but the present invention is applicable to ticket processing of such as a coupons of product or service other than the entrance processing.

For example, the terminal apparatus 11 starts the ticket processing application program, and accesses to the server 15 according to the program and may perform ticket purchase processing.

In the present embodiment, the terminal apparatus 11 starts the entrance processing using the ticket use operation according to the movement of finger on the screen as a trigger, but the terminal apparatus 11 may judge whether or not audio data input satisfies a predetermined condition and use the result of judgment as the trigger.

In addition, the ticket processing system 1 may support to make it possible to transfer the ticket data which a predetermined ticket buyer acquired to other people. For example, when a ticket data which is stored in the terminal apparatus 11 of a user is transmitted to the terminal apparatus 11 of the other users, the ticket data will be available.

In addition, the terminal apparatus 11 may set to enable reentrance after making the status data indicate entrance processing finished by completing update processing. And event staff enters a password which is known only by the event staff at the time of reentrance.

In addition, user can receive a product or a service according a coupon data by displaying image of coupon according to the coupon data downloaded in the terminal apparatus 11 at the time of entrance processing on the screen.

In addition, as shown in FIG. 1, the server 15 may produce a chat room that only event participants can contribute during event holding on a website.

In addition, the server 15 makes the terminal apparatus 11 download the contents data or contents program relating to the event of the ticket data with the ticket data.

And when the terminal apparatus 11 detects the ticket use operation, the terminal apparatus 11 transmits a use history data of the downloaded contents data or the contents program to the server 15.

For example, the processing circuit 25 may divide the area to be updated 514 in a plurality of domains and perform update processing when the pattern 301 matches a pattern which moves from a predetermined domain into a predetermined other domain.

1. A method for ticket processing, comprising:
a first step downloading a ticket data to a portable terminal apparatus from a server;
a second step taking the ticket data which is downloaded in a ticket processing application program which is started in the portable terminal apparatus;
a third step in which the portable terminal apparatus displays the image according to the ticket data on a screen based on the ticket processing application program; and
a fourth step in which the portable terminal apparatus detects a predetermined operation on a screen when a movement course of contact position of finger of user is a predetermined pattern decided beforehand and updates a status data indicating use history of the ticket data when the predetermined operation is detected.

2. A method for ticket processing as set forth in claim 1,
wherein
the ticket data includes at least one information of a position condition and a time condition for permitting to update the ticket data used status,
the update processing is performed when at least one condition of a first condition that position information of the portable terminal apparatus satisfies the position condition and a second condition that time of the detection of the movement course of contact position satisfies the time condition is satisfied in the fourth step.

3. A method for ticket processing as set forth in claim 2,
wherein
when a area to be updated is determined on the screen based on a cutting off position that is determined on the screen beforehand,
the portable terminal apparatus updates the status data and updates the image in the area to be updated from an image before the update processing to an image after update processing which is selected beforehand or selected based on a selection pattern among a plurality of images after update processing.

4. A method for ticket processing as set forth in claim 2,
wherein
the portable terminal apparatus downloads a contents data or a coupon data connecting to the ticket data from the server,
and transmits the use history data of the contents data or the coupon data to the server.

5. A method for ticket processing as set forth in claim 4,
wherein
the ticket data indicates an available number of times and includes information used for determining whether the ticket data is available or not,
the ticket data updates the status data on the condition when judging the ticket data is available based on the available number of times after detecting that the movement course of contact position of finger of user matches the predetermined pattern in the screen displayed in the third step.

6. A method for ticket processing as set forth in claim 5,
wherein
after the designation of the number of times to be used, the update is performed on the condition that it is judged that the ticket data is available based on the designated number of times and the available number of times in the fourth step.

7. A method for ticket processing as set forth in claim 6,
wherein
the update is performed when the movement course of the predetermined pattern exists in the fourth step.

8. A method for ticket processing as set forth in claim 1,
wherein
a plurality of patterns are defined as the predetermined pattern, and the image after the update processing is corresponded to each of the plurality of patterns,
the portable terminal apparatus updates the status data and update the image in the area to be updated from the image before the update processing to the image after the update processing corresponding to the predetermined pattern detected on the condition when detecting that the movement course of contact position of finger of user in the area to be updated is the predetermined pattern in the fourth step.

9. A method for ticket processing as set forth in claim 2,
wherein
the portable terminal apparatus comprises
a touch panel detecting a coordinate of the contact position in the screen, and
a control circuit identifying input operation based on the coordinate detected in the touch panel and performing a processing according to the input operation which is identified,
when a detection coordinate is defined by a first coordinate and a second coordinate which are detected in the touch panel and which form at right angles each other on two dimensions of the touch panel,
the portable terminal apparatus performs
a first process judging whether or not the detected coordinate exists in the domain which is defined as the area to be updated;
a second process judging whether or not both of the first coordinate and the second coordinate of the detected coordinate has changed when an affirmation judgment is obtained in the first process;
a third process judging whether or not the first coordinate reaches one end region of the direction in which the first coordinate of the touch panel is defined when an affirmation judgment is obtained in the second process;
a fourth process dividing by a predetermined time interval between a first timing when the detected coordinate which an affirmation judgment is obtained first time in the first processing is detected and a second timing when the first coordinate reaches to one end region in the third process, and calculating an amount of change of the detected coordinate in each divided time,
a fifth process judging whether or not an amount of change of all of the time interval divided in the fourth process exceed a predetermined threshold; and
sixth process judging the predetermined operation has detected when affirmation judgment is obtained in the fifth process.

10. A program which is downloaded in a portable terminal apparatus which comprises:
a touch panel detecting the coordinate of the contact position in the screen, and
a control circuit identifying input operation based on the coordinate detected in the touch panel and performing a processing according to the input operation which is identified,
and which makes the control circuit execute
a first step downloading a ticket data to a portable terminal apparatus from a server;
a second step taking the ticket data which is downloaded in a ticket processing application program which is started in the portable terminal apparatus;
a third step in which the portable terminal apparatus displays the image according to the ticket data on a screen based on the ticket processing application program; and
a fourth step in which the portable terminal apparatus detects a predetermined operation on a screen when a movement course of contact position of finger of user is a predetermined pattern decided beforehand and updates a status data indicating use history of the ticket data when the predetermined operation is detected.
